(19) United States
(12) Patent Application Publication
(10) Pub. No.: US 2026/0194104 A1
(43) Pub. Date: Jul. 9, 2026

(54) DOUBLE-ENDED MAGNETIC HOOK WITH ROTATING FUNCTION AND LOCK

(71) Applicant: Best-in Trading Company, Yangjiang city (CN)

(72) Inventor: Yan Liang, Yangjiang City (CN)

(73) Assignee: Best-in Trading Company, Yangjiang city (CN)

(21) Appl. No.: 19/027,524

(22) Filed: Jan. 17, 2025

(30) Foreign Application Priority Data
Jan. 8, 2025 (CN) 202520041108.9

(51) Int. Cl. F16B 45/02; F16M 13/02

(52) U.S. Cl. CPC F16B 45/037; F16M 13/022; F16B 2200/83

(57) ABSTRACT

The invention discloses a magnetic hook, relating to the technical field of hooks. The hook comprises a first mounting column, wherein a bearing column is mounted at the bottom of the column; a second mounting column is mounted on the bottom outer wall of the column; a hook component is mounted on each of the top outer wall of the first mounting column and the bottom outer wall of the second mounting column. The rotating component can allow the second mounting column and the hook component to rotate and adjust the hook component orientation to hook objects in different directions. Through magnetic attraction of the magnetic component and fixed connection of the connecting component, connection between the first mounting column and the bearing column is tighter and more reliable, heaver objects are more convenient to hook, and the disassembly process is simple and fast, aiding in subsequent maintenance.

### REFERENCE TO PRIOR APPLICATION

This application claims priority to Chinese Patent Application 202520041108.9, filed on Jan. 8, 2025, which is incorporated herein by reference.

### TECHNICAL FIELD

This present invention relates to the technical field of hooks, in particular to a double-ended magnetic hook with a rotating function and a lock.

### BACKGROUND ART

A double-ended hook is a hook device designed with two hooks, typically used for enhancing the space availability factor and suitable for hanging multiple objects.

The double-ended hook with patent publication number CN220655338U comprises a first hook and a second hook, wherein the first hook comprises a first straight rod part and a first curved hook part; the first straight rod part is equipped with an elastic protrusion; the second hook comprises a second straight rod part and a second curved hook part; the second straight rod part is provided with a plurality of fixing holes; the elastic protrusion can be selectively inserted into any of the fixing holes to connect the first hook and the second hook. The double-ended hook proposed in the present application connects the first hook and the second hook by means of the elastic protrusion of the first straight rod part and the fixing holes in the second straight rod part. Additionally, by adjusting the elastic protrusion to select different fixing holes, the length of the hook can be adjusted, enabling the double-ended hook to be applied to different usage scenarios and enhancing the practicality of the double-ended hook.

In the prior art, the hook parts of double-ended hooks often face the same fixed direction or different directions, resulting in the disadvantages of unadjustable hook orientation and low flexibility of the double-ended hooks. Consequently, in practical use, the requirements of adjusting the hook orientation and hooking objects in different orientations cannot be met. Therefore, a double-ended magnetic hook with a rotating function and a lock is proposed.

### SUMMARY

The purpose of the present invention is to provide a double-ended magnetic hook with a rotating function and a lock, to solve the problems raised in the aforementioned background technology.

In order to achieve the aforementioned purpose, the present invention provides the following technical solution: a double-ended magnetic hook with a rotating function and a lock comprises a first mounting post, wherein a bearing column is mounted at the bottom of the first mounting column through a magnetic component and a connecting component; a second mounting column is mounted on the outer wall of the bottom of the bearing column through a rotating component; a hook component is mounted on each of the outer wall of the top of the first mounting column and the outer wall of the bottom of the second mounting column; all the interiors of the first mounting column, the second mounting column and the bearing column are hollow structures;

the rotating component comprises a fixing ring mounted on the inner wall of the bottom of the bearing column; a vertical groove is formed in the outer wall of the bottom of the load column, which communicates with the annular part of the fixing ring; a first placing rack is mounted on the inner wall of the second mounting column; a vertical column matched with the vertical groove is mounted in the middle of the first placing rack; the vertical column is inserted into the vertical groove in the bearing column.

Further, the rotating assembly further comprises a limiting groove formed in the outer wall of the vertical column; an elastic ring is clamped with the interior of the limiting groove; when the vertical column is inserted into the vertical groove in the bearing column, the limiting groove is formed in the top of the fixing ring; the limiting and falling prevention of the second mounting column are accomplished through the elastic ring in combination with the fixing ring; notches are formed in the outer walls of the two sides of the second mounting column.

Further, the hook component comprises a hook body mounted on the outer wall of the top of the first mounting column and the outer wall of the bottom of the second mounting column; a bump is mounted at the notch of the inner wall of the hook body; a side groove is formed in each of the outer wall of the top of the first mounting column and the outer wall of the bottom of the second mounting column; the outer wall of the top of the first mounting column and the outer wall of the bottom of the second mounting column form horizontal blocks through the side grooves; a shackle is rotationally connected with each horizontal block.

Further, the connecting component comprises main vertical blocks mounted on the outer walls of the two sides of the first mounting column; a U-shaped column is rotationally connected to each main vertical block; an auxiliary vertical block is mounted on the outer wall of each side of the bearing column; side blocks are mounted at the two ends of the auxiliary vertical block on the outer wall of the bearing column; the U-shaped column is rotationally clamped with a gap between the auxiliary vertical block and the side block.

Further, the magnetic component comprises a second placing rack mounted on the inner wall of the top of the first mounting column; a first magnetic block is mounted on the second placing rack inside the first mounting column; a plurality of square blocks are mounted on the inner wall of the bottom of the bearing column; a second magnetic block is mounted on the square blocks inside the bearing column; a trapezoidal ring is mounted on the outer wall of the bottom of the first mounting column; an annular groove matched with the trapezoidal ring is formed in the outer wall of the top of the second mounting column; the mounting of the bearing column and the first mounting column is accomplished through the trapezoidal ring being inserted into the annular groove and the mutual adsorption of the first magnetic block and the second magnetic block.

Further, each of the middles of the first placing rack structure and the second placing rack structure is a circular ring; a plurality of horizontal blocks are fixedly connected to the outer wall of the circular ring; the circular ring in the first placing rack is fixedly connected to the inner wall of the bottom of the second mounting column; the horizontal blocks in the first placing rack are fixedly connected to the circumferential inner wall of the second mounting column; the circular ring in the second placing rack is fixedly connected to the inner wall of the top of the first mounting column; the horizontal blocks in the second placing rack are fixedly connected to the circumferential inner wall of the first mounting column.

Compared to the prior art, the present invention has the following beneficial effects:

The double-ended magnetic hook with the rotating function and the lock can allow the second mounting column and the hook component at the bottom of the second mounting column to rotate at the bottom of the bearing column through the rotating component, enable the orientation of the hook component to be adjustable, and improve the flexibility, to meet the requirement that the hook component hook objects in different orientations. The double-ended magnetic hook can ensure that the connection between the first mounting column and the bearing column is tighter and more reliable through the magnetic attraction effect of the magnetic component in combination with the fixed connection of the connecting component, to hook heaver objects. Additionally, the disassembly process is simple and fast, aiding in subsequent maintenance.

Meanwhile, through the trapezoidal ring and the annular groove provided in the magnetic component, the connection between the first mounting column and the bearing column can be closer; as all the interiors of the first mounting column, the second mounting column and the bearing column are hollow structures, the overall weight of the double-ended hook can be reduced, and lightweight design is achieved, making the hook convenient to carry; as each of the middles of the first placing rack structure and the second placing rack structure is a circular ring, and a plurality of horizontal blocks are fixedly connected with the outer wall of the circular ring, the horizontal blocks can be equal to reinforcing ribs, and the strength of the first mounting column and second mounting column are enhanced, and the effect of ensuring strength while being lightweight is achieved.

### BRIEF DESCRIPTION OF DRAWINGS

FIG. 1 is an overall schematic diagram of the present invention;

FIG. 2 is a schematic diagram of the hook component of the present invention;

FIG. 3 is an internal schematic diagram of the first mounting column of the present invention;

FIG. 4 is a schematic diagram of the annular groove of the present invention;

FIG. 5 is an internal schematic diagram of the bearing column of the present invention;

FIG. 6 is a schematic diagram of the top of the second mounting column of the present invention.

In the figures: 1, first mounting column; 2, hook component; 201, hook body; 202, bump; 203, shackle; 204, side groove; 3, connecting component; 301, main vertical block; 302, U-shaped column; 303, side block; 304, secondary vertical block; 4, rotating component; 401, fixing ring; 402, vertical column; 403, elastic ring; 404, first placing rack; 405, limiting groove; 406, notch; 5, second mounting column; 6, bearing column; 7, first magnetic block; 8, second placing rack; 9, trapezoidal ring; 10, annular groove; 11, second magnetic block; 12, square block.

### DETAILED DESCRIPTION OF EMBODIMENTS

The technical scheme in the embodiments of the present invention will be clearly and completely described below in conjunction with the following drawings of the embodiments of the present invention. Apparently, the described embodiments are only a part of embodiments rather than all embodiments. Based on the embodiments of the present invention, all other embodiments obtained by ordinary technicians in the field without making any creative efforts shall fall within the scope of protection of the present invention.

During the process of hooking items, hooks are required to be used. The double-ended magnetic hook provided by the present is specifically designed for complex object hooking needs. The double-hook design can allow for hanging two objects simultaneously, saves space, and can be applied to homes, offices, workshops or commercial environment, and is high in flexibility.

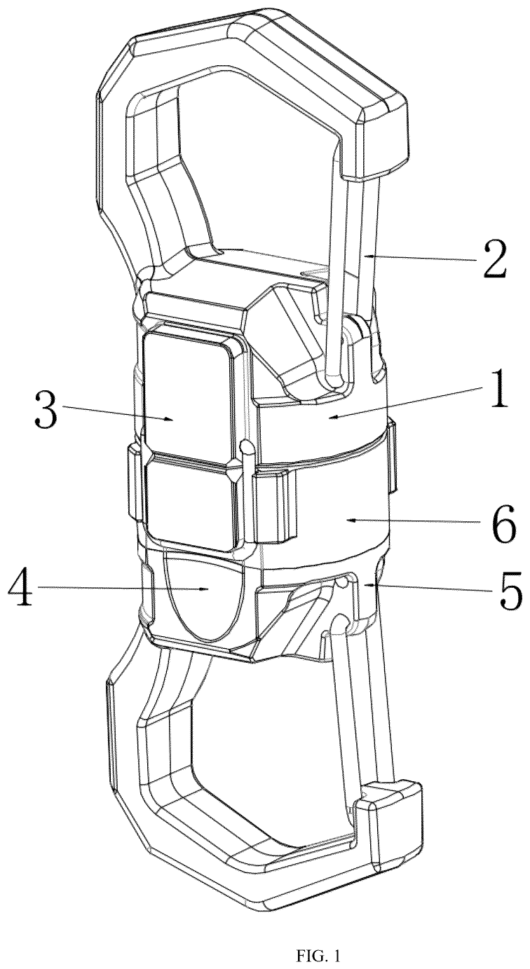

As shown in FIG. 1 to FIG. 6, the present invention provides a technical scheme: a double-ended magnetic hook, with a rotation function and a lock, comprises a first mounting column 1, wherein a bearing column 6 is mounted at the bottom of the first mounting column 1 through a magnetic component and a connecting component 3; a second mounting column 5 is mounted on the outer wall of the bottom of the bearing column 6 through a rotating component 4; a hook component 2 is mounted on each of the outer wall of the top of the first mounting column 1 and the outer wall of the bottom of the second mounting column 5; all the interiors of the first mounting column 1, the second mounting column 5 and the bearing column 6 are hollow structures;

the rotating component 4 comprises a fixing ring 401 mounted on the inner wall of the bottom of the bearing column 6; a vertical groove is formed in the outer wall of the bottom of the load column 6, which communicates with the annular part of the fixing ring 401; a first placing rack 404 is mounted on the inner wall of the second mounting column 5; a vertical column 402 matched with the vertical groove is mounted in the middle of the first placing rack 404; the vertical column 402 is inserted into the vertical groove in the bearing column 6.

It should be noted that through the hook component 2 on the first mounting column 1 and the second mounting column 5, double-hook design can be achieved, to hang two objects simultaneously; through the matching between the magnetic component and the connecting component 3, the first mounting column 1 is connected with the bearing column 6; through the magnetic attraction effect of the magnetic component in combination with the fixed connection of the connecting component 3, the connection between the first mounting column 1 and the bearing column 6 is tighter and more reliable; in addition, the assembly process is simple and fast, aiding subsequent maintenance; through the provision of the rotating component 4, the second mounting column 5 and the hook component 2 at the bottom of the second mounting column 5 can rotate at the bottom of the bearing column 6; as all the interiors of the first mounting column 1, the second mounting column 5 and the bearing column 6 are hollow structures, the overall weight of the double-ended hook can be reduced, and lightweight design is achieved, making the hook convenient to carry.

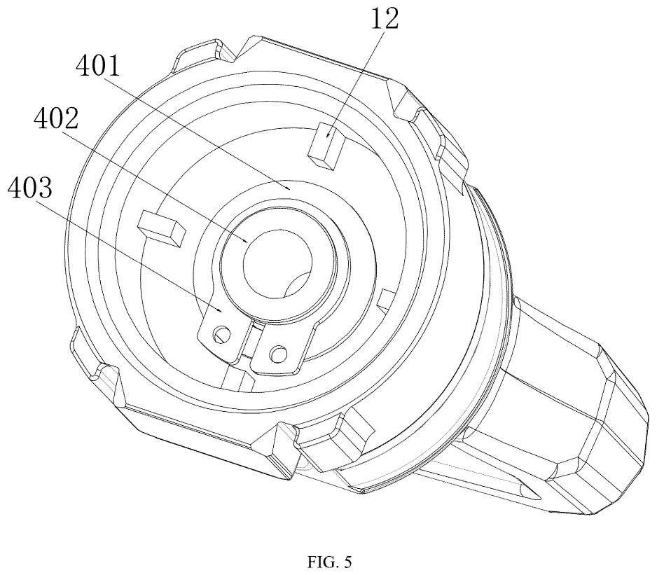

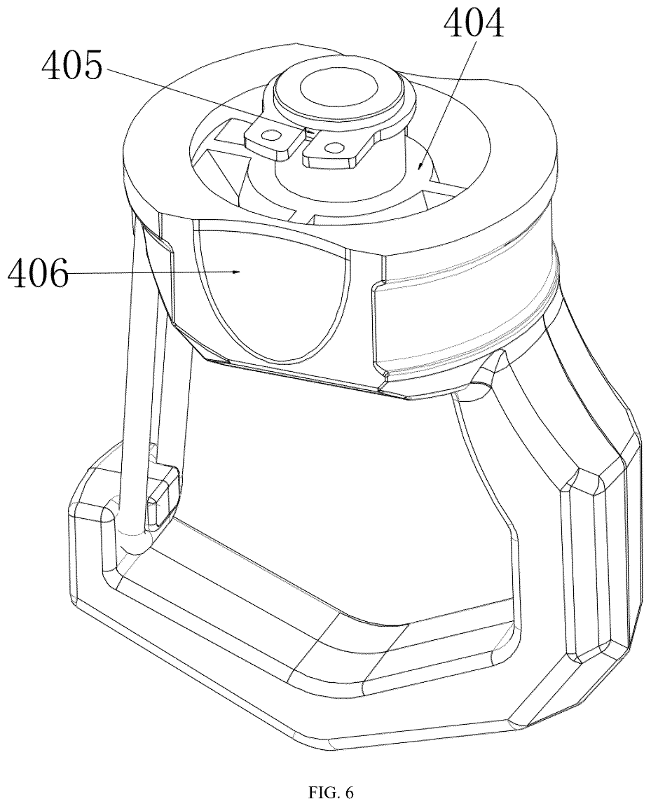

As shown in FIG. 5 and FIG. 6, the rotating component 4 further comprises a limiting groove 405 formed in the outer wall of the vertical column 402; an elastic ring 403 is clamped with the interior of the limiting groove 405; when the vertical column 402 is inserted into the vertical groove in the bearing column 6, the limiting groove 405 is formed in the top of the fixing ring 401; the limiting and falling prevention of the second mounting column 5 are accomplished through the elastic ring 403 in combination with the fixing ring 401; notches 406 are formed in the outer walls of the two sides of the second mounting column 5.

It should be noted that the second mounting column 5 can be rotated by mutually rotating the second mounting column 5 through working personnel; through the provision of the elastic ring 403, the limiting groove 405 in combination with the fixing ring 401, falling of the second mounting column 5 from the bearing column 6 can be prevented, and the hook is convenient to use; for the specific disassembly process, by pulling the elastic ring 403 to remove the elastic ring 403 from the limiting groove 405 and then pulling down the second mounting column 5, the second mounting column 5 can be disassembled from the bearing column 6, to perform disassemble, repair and replacement.

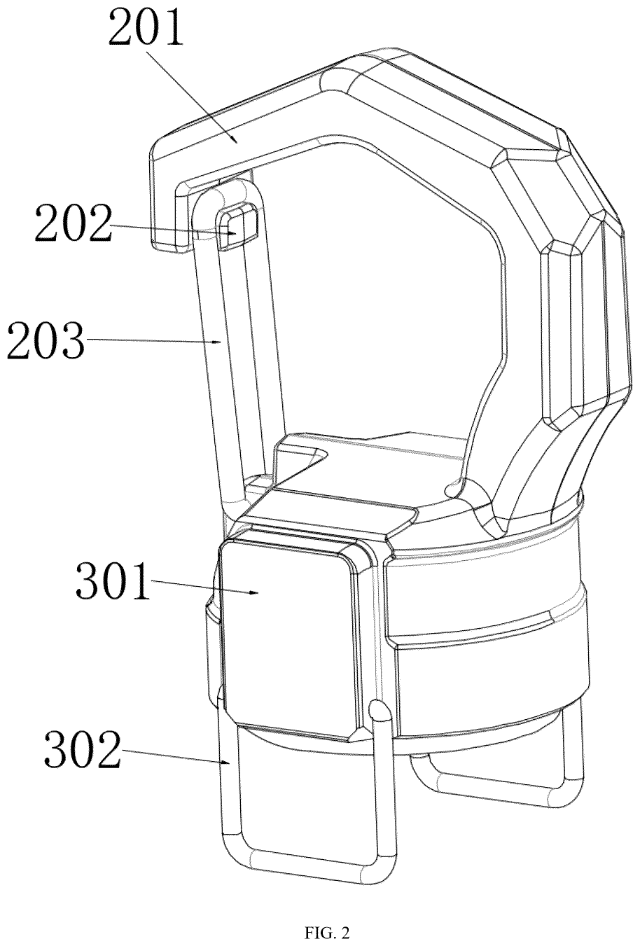

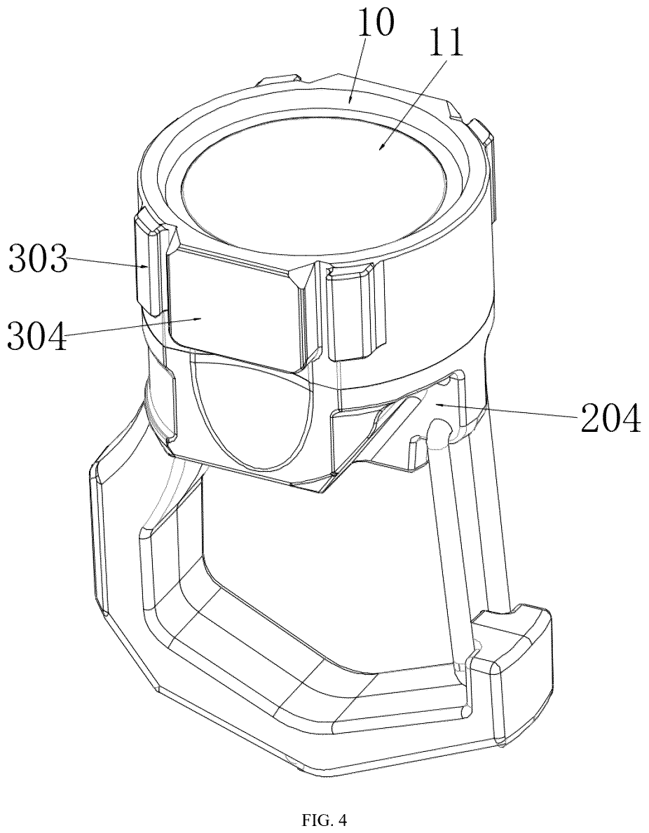

As shown in FIG. 2 and FIG. 4, the hook component 2 comprises a hook body 201 mounted on the outer wall of the top of the first mounting column 1 and the outer wall of the bottom of the second mounting column 5; a bump 202 is mounted at the notch of the inner wall of the hook body 201; a side groove 204 is formed in each of the outer wall of the top of the first mounting column 1 and the outer wall of the bottom of the second mounting column 5; the outer wall of the top of the first mounting column 1 and the outer wall of the bottom of the second mounting column 5 form horizontal blocks through the side grooves 204; a shackle 203 is rotationally connected with each horizontal block.

It should be noted that when the hook component 2 is required to be used, through the hook body 201, objects can be hooked; during hooking, through the rotation of the shackle 203, the shackle 203 is buckled to the outer wall of the bump 202, the hook body 201 can be closed; conversely, the hook body 201 can be opened to remove the hooked objects.

As shown in FIG. 2 and FIG. 4, the connecting component 3 comprises main vertical blocks 301 mounted on the outer walls of the two sides of the first mounting column 1; a U-shaped column 302 is rotationally connected to each main vertical block 301; an auxiliary vertical block 304 is mounted on the outer wall of each side of the bearing column 6; side blocks 303 are mounted at the two ends of the auxiliary vertical block 304 on the outer wall of the bearing column 6; the U-shaped column 302 is rotationally clamped with a gap between the auxiliary vertical block 304 and the side block 303.

It should be noted that when the connecting component 3 is required to be used, and when the first mounting column 1 and the bearing column 6 are required to be separated from each other, through the rotation of the U-shaped column 302, the U-shaped column 302 is pulled out from the gap between the auxiliary vertical block 304 and the side block 303, and then through the pulling of the first mounting column 1 and the bearing column 6 in the opposite direction, the first mounting column 1 and the bearing column 6 can be separated from each other.

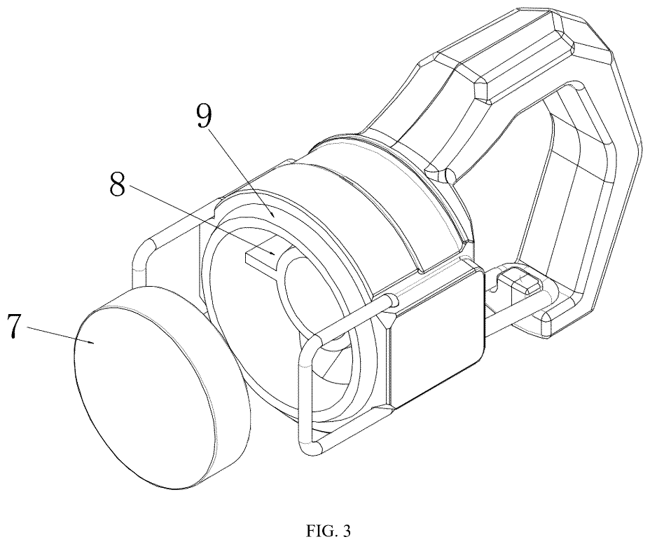

As shown in FIGS. 3 and 4, the magnetic component comprises a second placing rack 8 mounted on the inner wall of the top of the first mounting column 1; a first magnetic block 7 is mounted on the second placing rack 8 inside the first mounting column 1; a plurality of square blocks 12 are mounted on the inner wall of the bottom of the bearing column 6; a second magnetic block 11 is mounted on the square blocks 12 inside the bearing column 6; a trapezoidal ring 9 is mounted on the outer wall of the bottom of the first mounting column 1; an annular groove 10 matched with the trapezoidal ring 9 is formed in the outer wall of the top of the second mounting column 5; the mounting of the bearing column 6 and the first mounting column 1 is accomplished through the trapezoidal ring 9 being inserted into the annular groove 10 and the mutual adsorption of the first magnetic block 7 and the second magnetic block 11.

It should be noted that through the provision of the magnetic component, the first mounting column 1 can be connected with the bearing column 6 through a magnetic attraction manner; through the provision of the connecting component 3, the second layer of connection and fixing is performed to ensure that the connection between the first mounting column 1 and the bearing column 6 is tighter and firmer, so that heaver objects can be hooked; through the provision of the trapezoidal ring 9 and the annular groove 10, the connection between the first mounting column 1 and the bearing column 6 can be closer; through the provision of the first magnetic block 7 and the second magnetic block 11, the magnetic connection between the first mounting column 1 and the bearing column 6 is accomplished.

As shown in FIG. 3 and FIG. 6, each of the middles of the first placing rack 404 structure and the second placing rack 8 structure is a circular ring; a plurality of horizontal blocks are fixedly connected to the outer wall of the circular ring; the circular ring in the first placing rack 404 is fixedly connected to the inner wall of the bottom of the second mounting column 5; the horizontal blocks in the first placing rack 404 are fixedly connected to the circumferential inner wall of the second mounting column 5; the circular ring in the second placing rack 8 is fixedly connected to the inner wall of the top of the first mounting column 1; the horizontal blocks in the second placing rack 8 are fixedly connected to the circumferential inner wall of the first mounting column 1.

It should be noted that through the provision of the first placing rack 404 and the second placing rack 8, the effect of bearing can be achieved; meanwhile, as each of the middles of the first placing rack 404 structure and the second placing rack 8 structure is a circular ring, and the plurality of horizontal blocks are fixedly connected with the outer wall of the circular ring, the horizontal blocks can be equal to reinforcing ribs, the strength of the first mounting column 1 and second mounting column 5 are enhanced, and the hook is convenient to use.

Although the embodiments of the present invention have been shown and described, it will be understood by those skilled in the art that various changes, modifications, substitutions and variations may be made to these embodiments without departing from the principles and spirit of the present invention, and the scope of the present invention is defined by the appended embodiments and their equivalents.

What is claimed is:

1. A double-ended magnetic hook with a rotating function and a lock, comprising a first mounting column (1), characterized in that a bearing column (6) is mounted at the bottom of the first mounting column (1) through a magnetic component and a connecting component (3); a second mounting column (5) is mounted on the outer wall of the bottom of the bearing column (6) through a rotating component (4); a hook component (2) is mounted on each of the outer wall of the top of the first mounting column (1) and the outer wall of the bottom of the second mounting column (5); all the interiors of the first mounting column (1), the second mounting column (5) and the bearing column (6) are hollow structures;
the rotating component (4) comprises a fixing ring (401) mounted on the inner wall of the bottom of the bearing column (6); a vertical groove is formed in the outer wall of the bottom of the load column (6), which communicates with the annular part of the fixing ring (401); a first placing rack (404) is mounted on the inner wall of the second mounting column (5); a vertical column (402) matched with the vertical groove is mounted in the middle of the first placing rack (404); the vertical column (402) is inserted into the vertical groove in the bearing column (6).

2. The double-ended magnetic hook with the rotating function and the lock according to claim 1, characterized in that the rotating component (4) further comprises a limiting groove (405) formed in the outer wall of the vertical column (402); an elastic ring (403) is clamped with the interior of the limiting groove (405); when the vertical column (402) is inserted into the vertical groove in the bearing column (6), the limiting groove (405) is formed in the top of the fixing ring (401); the limiting and falling prevention of the second mounting column (5) are accomplished through the elastic ring (403) in combination with the fixing ring (401); notches (406) are formed in the outer walls of the two sides of the second mounting column (5).

3. The double-ended magnetic hook with the rotating function and the lock according to claim 1, characterized in that the hook component (2) comprises a hook body (201) mounted on the outer wall of the top of the first mounting column (1) and the outer wall of the bottom of the second mounting column (5); a bump (202) is mounted at the notch of the inner wall of the hook body (201); a side groove (204) is formed in each of the outer wall of the top of the first mounting column (1) and the outer wall of the bottom of the second mounting column (5); the outer wall of the top of the first mounting column (1) and the outer wall of the bottom of the second mounting column (5) form horizontal blocks through the side grooves (204); a shackle

(203) is rotationally connected with each horizontal block.

4. The double-ended magnetic hook with the rotating function and the lock according to claim 1, characterized in that the connecting component (3) comprises main vertical blocks (301) mounted on the outer walls of the two sides of the first mounting column (1); a U-shaped column (302) is rotationally connected to each main vertical block (301); an auxiliary vertical block (304) is mounted on the outer wall of each side of the bearing column (6); side blocks (303) are mounted at the two ends of the auxiliary vertical block (304) on the outer wall of the bearing column (6); the U-shaped column (302) is rotationally clamped with a gap between the auxiliary vertical block (304) and the side block (303).

5. The double-ended magnetic hook with the rotating function and the lock according to claim 1, characterized in that the magnetic component comprises a second placing rack (8) mounted on the inner wall of the top of the first mounting column (1); a first magnetic block (7) is mounted on the second placing rack (8) inside the first mounting column (1); a plurality of square blocks (12) are mounted on the inner wall of the bottom of the bearing column (6); a second magnetic block (11) is mounted on the square blocks (12) inside the bearing column (6); a trapezoidal ring (9) is mounted on the outer wall of the bottom of the first mounting column (1); an annular groove (10) matched with the trapezoidal ring (9) is formed in the outer wall of the top of the second mounting column (5); the mounting of the bearing column (6) and the first mounting column (1) is accomplished through the trapezoidal ring (9) being inserted into the annular groove (10) and the mutual adsorption of the first magnetic block (7) and the second magnetic block (11).

6. The double-ended magnetic hook with the rotating function and the lock according to claim 1, characterized in that each of the middles of the first placing rack (404) structure and the second placing rack (8) structure is a circular ring; a plurality of horizontal blocks are fixedly connected to the outer wall of the circular ring; the circular ring in the first placing rack (404) is fixedly connected to the inner wall of the bottom of the second mounting column (5); the horizontal blocks in the first placing rack (404) are fixedly connected to the circumferential inner wall of the second mounting column (5); the circular ring in the second placing rack (8) is fixedly connected to the inner wall of the top of the first mounting column (1); the horizontal blocks in the second placing rack (8) are fixedly connected to the circumferential inner wall of the first mounting column (1).
